(19) United States
(12) Patent Application Publication
(10) Pub. No.: US 2004/0117069 A1
(43) Pub. Date: Jun. 17, 2004

(54) Central control system for controlling multiple air conditioners and method for operating the same

(75) Inventors: Sang Chul Yoon, Kyungki-do (KR); Duck Gu Jeon, Seoul (KR); Jae Sik Jung, Seoul (KR); Jae Hwan Kwon, Seoul (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 10/702,469

(22) Filed: Nov. 7, 2003

(30) Foreign Application Priority Data
Dec. 2, 2002 (KR) 2002-75974

(51) Int. Cl. H02P 1/00

(52) U.S. Cl. 700/276

(57) ABSTRACT

A central control system and method is provided for controlling multiple air conditioners that include an outdoor device and a plurality of indoor devices. A central controller is connected through a dedicated line based on an air conditioner communication protocol to control the multiple air conditioners. The central controller is serially connected to a protocol converter for carrying out an Ethernet communication protocol conversion and an air conditioner communication protocol conversion. The central controller allows for remote control of the multiple air conditioners through an external Internet network based on the Ethernet communication protocol. Accordingly, data of different communication protocols are smoothly transmitted and received, and a stable control operation can be performed.

### CROSS-REFERENCE TO RELATED APPLICATION

The present application claims priority under 35 U.S.C. § 119 of Korean Application No. 2002-75974, which was filed on Dec. 2, 2002, the disclosure of which is expressly incorporated by reference herein in its entirety.

### BACKGROUND OF THE INVENTION

1. Field of the Invention

The present invention relates to a central control system for controlling multiple air conditioners and a method for operating the same. More particularly the present invention relates to a central control system, and a method for operating the same, which can control multiple air conditioners by operation of a central controller connected to the multiple air conditioners through a dedicated line and based on an air conditioner communication protocol. The central control system performs a communication protocol conversion to allow the multiple air conditioners to be remotely controlled through an external Internet network based on an Ethernet communication protocol.

2. Description of the Related Art

A conventional system for controlling multiple air conditioners will be described with reference to FIG. 1.

An air conditioner generally includes an indoor component and an outdoor component A coolant is circulated through the indoor and outdoor devices, and establishes a thermal cycle of compression, condensation, expansion and evaporation. In this manner, conditioning of indoor air is performed by a heating or cooling operation.

A multiple air conditioner system includes a single outdoor device 20 and a plurality of indoor devices 10. Since the respective indoor devices 10 can be individually controlled to selectively or simultaneously perform cooling operations, the multiple air conditioner system is cost-effective and efficient. In general, a single outdoor device 20 is provided, and plural indoor devices 10 connected to the single outdoor device 20 are installed in different rooms or areas within a building. In multilevel buildings, separate outdoor and indoor devices may be provided on every floor.

In order for the multiple air conditioners to independently perform cooling operations, the outdoor device 20 must individually control the operating conditions of the indoor devices 10 connected to the outdoor device 20. When an operator inputs a cooling operation command into an indoor device 10, the outdoor device 20 connected to the indoor device 10 identifies the specific cooling operation command and the specific indoor device, and adjusts coolant circulation accordingly, to perform a cooling operation corresponding to the cooling operation command.

However, if errors are detected in indoor devices of a conventional multiple air conditioner system, a worker must go to locations of the indoor devices or the outdoor device connected to the indoor devices in order to manually input a control command for repairing and maintenance into the indoor devices or the outdoor device. If a plurality of outdoor devices are provided on different floors within a large building, the manpower and cost requirements for managing the outdoor devices increase significantly.

If a central controller is connected to the outdoor devices, the outdoor devices and indoor devices connected to each outdoor device can be controlled in a limited manner without manually accessing each outdoor device. However, such a central controller can only perform functions of a simple nature based on a simple command input, such as a power on/off command input, and an identification function. This presents a problem since all of the functions and features of the outdoor and indoor devices cannot be controlled.

Further, if the central controller is connected to an external Internet network, a communication protocol of a signal transmitted and received through the Internet network is different from the protocol of a signal that can be recognize by the multiple air conditioners. Since a control command input by a remote control operator accessing the eternal Internet network cannot be recognized by the multiple air conditioners, the multiple air conditioners cannot be remotely controlled.

### SUMMARY OF THE INVENTION

Therefore, the present invention has been made in view of the above problems, and it is an object of the present invention to provide a central control system for controlling multiple air conditioners and a method for operating the same. The system and method can stably and remotely control the multiple air conditioners by transmitting signals of different communication protocols through a central controller, such that control command data can be smoothly exchanged between the multiple air conditioners and a remote controller. The multiple air conditioners transmit and receive signals based on an air conditioner communication protocol between outdoor and indoor devices, and a remote controller transmits a control command signal based on an Ethernet communication protocol through an external Internet network.

In accordance with one aspect of the present invention, the above and other objects can be accomplished by the provision of a central control system that controls multiple air conditioners that include at least one outdoor device and a plurality of indoor devices. The central control system includes a central controller connected to the multiple air conditioners through a dedicated line for transmitting and receiving signals based on an air conditioner communication protocol to control the multiple air conditioners. The central controller is also connected to an external Internet network for transmitting and receiving signals based on an Ethernet communication protocol to receive a control command for the multiple air conditioners. The central control system also includes a protocol converter that performs a communication protocol conversion of a signal, whereby the control command input at a remote location can be transmitted to the multiple air conditioners through the Internet network.

In accordance with another aspect of the present invention, a method of operating a central control system for multiple air conditioners is provided. The method includes receiving a control command for the multiple air conditioners that is transmitted from a remote controller over an Internet network; converting the received control command into a control command based on an air conditioner communication protocol; transmitting the control command based on the air conditioner communication protocol to the multiple air conditioners; performing a control operation of the multiple air conditioners in response to the control command based on the air conditioner communication protocol; and transmitting data representing control conditions of the multiple air conditioners to the remote controller over the Internet network.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating a conventional system for controlling multiple air conditioners;

FIG. 2 is a view illustrating the configuration of a central control system for controlling multiple air conditioners in accordance with the present invention;

FIG. 3 is a view illustrating an internal configuration of the central control system for controlling the multiple air conditioners in accordance with the present invention; and

FIG. 4 is a flowchart illustrating a method for operating the central control system for controlling the multiple air conditioners in accordance with the present invention.

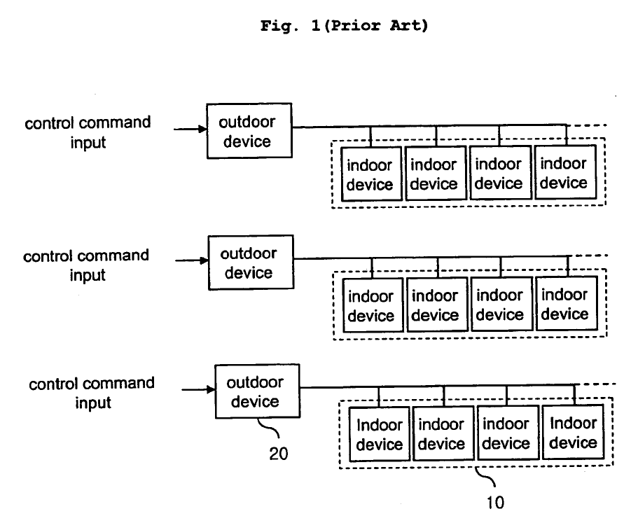

### DESCRIPTION OF THE PREFERRED EMBODIMENTS

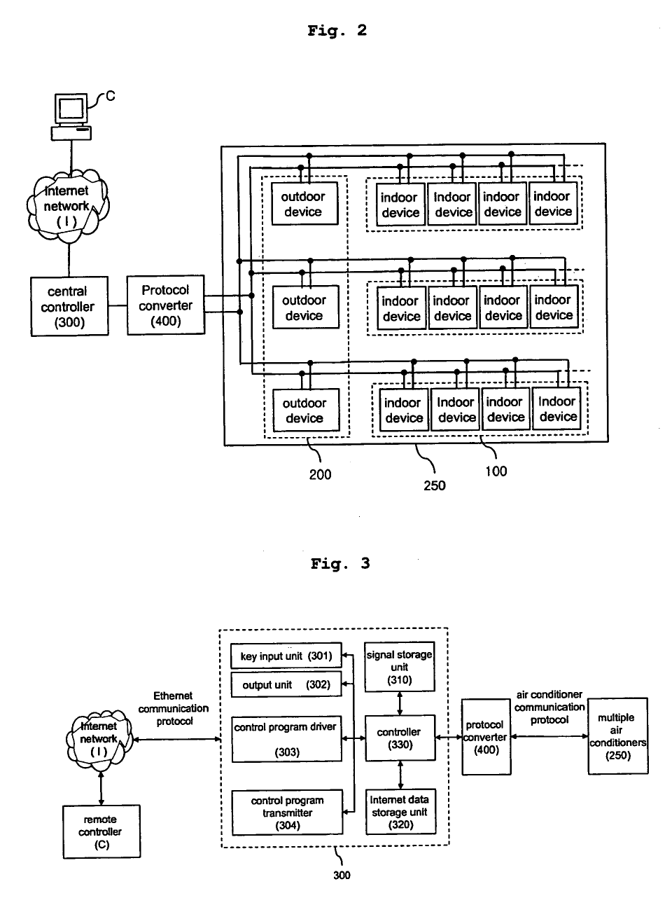

FIG. 2 is a view illustrating the configuration of a central control system for controlling multiple air conditioners in accordance with the present invention. FIG. 3 is a view illustrating an internal configuration of the central control system for controlling the multiple air conditioners in accordance with the present invention. The present invention will be described in detail with reference to FIGS. 2 and 3.

In the multiple air conditioners 250 in accordance with the present invention, at least one outdoor device 200 connected with a plurality of indoor devices 100 is provided. As shown in FIG. 3, the multiple air conditioners 250 can include a plurality of outdoor devices 200, each connected with a plurality of indoor devices 100. The installation of the multiple air conditioners 250 results in efficient utilization of installation space and reduced installation expense. Moreover, because one outdoor device 200 operates in conjunction with plural indoor devices 100, power consumption is reduced and energy efficiency is increased.

The outdoor device 200 includes a condenser for changing coolant from a high-temperature, high-pressure gaseous state to a liquid state. In the outdoor device 200, a compressor performs heat exchange between gas coolant and outdoor air. The high-temperature, high-pressure gas coolant passes through the outdoor device 200 to produce medium-temperature, high-pressure liquid coolant according to a condensation phenomenon. The outdoor device 200 includes an outdoor fan device having an outdoor fan and a motor for ventilating air to/from the outdoor device 200 to increase the heat exchange efficiency.

The medium-temperature, high-pressure liquid coolant is expanded by an expansion valve, so that a low-temperature, low-pressure liquid coolant passes through the indoor device 100. The liquid coolant absorbs heat from indoor air and is vaporized according to a vaporization phenomenon. In this manner, a temperature of the indoor air is lowered, so that an indoor cooling operation is performed. The indoor device 100 includes an indoor fan device having a motor and an indoor fan for ventilating hot or cool air indoors. In this regard as used herein the term air conditioner refers both to devices that heat as well as that cool air. Further humidifiers, dehumidifiers, as well as other air conditioning devices are included in the scope of this term.

The indoor devices 100 are installed at predetermined locations within a building. The indoor devices 100 are connected and networked to a dedicated line on the basis of an RS-485 communication protocol. The outdoor device 200 is also connected to the dedicated line and can control conditions of the indoor devices. The outdoor device 200 can receive a control command, adjust the circulation of a coolant, and transmit the control command to a corresponding indoor device 100.

RS-485 is a communication protocol used for a multi-point communication line as a serial communication interface protocol. RS-485 supports up to 32 nodes per line because it uses lower-impedance drivers and receivers. When using the RS-485 protocol, a transmission distance depends upon a transmission rate, but the maximum distance that data can be transmitted is approximately 1200 m. The RS-485 communication protocol is set forth herein as an example of an air conditioner communication protocol. However, it will be apparent to one skilled in the art that any suitable communication protocol could be used as the air conditioner communication protocol.

If a large number of indoor devices are installed within a large or multilevel building, a plurality of outdoor devices 200 may be connected to the indoor devices 100 through the dedicated line. The outdoor devices 200 are also connected to a central controller 300 through the dedicated line.

The central controller 300 controls the outdoor devices 200, and the outdoor devices 200 in turn control the indoor devices 100. An operator or system manager operates the central controller 300 to control the multiple air conditioner system through a central control operation.

The central controller 300 transmits and receives signals based on the air conditioner communication protocol. The central controller 300 is configured to control the multiple air conditioners 250 in a central control manner based on the air conditioner communication protocol and to also access an Internet network I based on any suitable protocol, such as an Ethernet communication protocol. The Ethernet communication protocol may be Transmission Control Protocol/Internet Protocol (TCP/IP). For remotely controlling the indoor devices 100, a remote controller C can access the central controller 300 through the Internet network I.

A control command can be input to the multiple air conditioner system 250 through the central controller 300 at a remote location. Moreover, operating conditions of the multiple air conditioners can be monitored at the remote location, and data indicating a result of the control operation corresponding to the control command can be displayed and indicated or identified at the remote location.

To perform the above-described functions, a communication protocol conversion must be performed for signals transmitted and received between an Ethernet communication protocol, such as TCP/IP, and an air conditioner communication protocol, such as RS-485. A protocol converter 400, which includes one or more data storage buffers, is connected to a serial port of the central controller 300 in accordance with serial protocol, such as RS-232 to perform the communication protocol conversion. A communication protocol conversion for the control command received through the Internet network from the remote location is performed such that the control command can be recognized by the multiple air conditioners 250. A communication protocol conversion for data indicating the result of the control operation, and operating conditions of the multiple air conditioners, is performed such that the data can be identified through the remote controller C.

Ethernet is a local area network, or LAN. Ethernet may be capable of exchanging information between 1,024 points at a transmission rate of 10 Mbps within about 2.5 km. Any suitable communication protocol such as TCP/IP, may be used as the Ethernet communication protocol.

The central controller 300 includes a signal storage device 310 that stores remote control commands received through the Internet network I and an Internet data storage device 320 that stores Internet access port data for accessing the external Internet network and IP address data. The central controller 300 also includes a controller 330 that controls the flow of signals transmitted and received through the Internet network and the protocol converter 400 for performing communication protocol conversion of a signal.

The central controller 300 further includes a key input device 301 that enables the controller to receive a control command for the multiple air conditioners, and an output device 302 that outputs operating condition data for the multiple air conditioners operated according to the control command.

The central controller 300 includes a control program driver 303 for a control program accessible by a GUI (Graphic User Interface) for conveniently controlling the multiple air conditioners 250. When the remote controller at the remote location transmits an air conditioner control request, a control program transmitter 304 of controller 304 can transmit the control program by downloading the same through a web browser by the remote controller.

The indoor devices 100 and the outdoor devices 200 are connected to a network using RS-485 protocol as the air conditioner communication protocol. The central controller 300 is connected to the multiple air conditioners through a dedicated line, and is also connected to the external Internet network I using an Ethernet communication protocol, such as TCP/IP. Accordingly, the manager or operator can control the outdoor devices 200 using the central controller 300, and can also perform a remote control operation through the Internet network I.

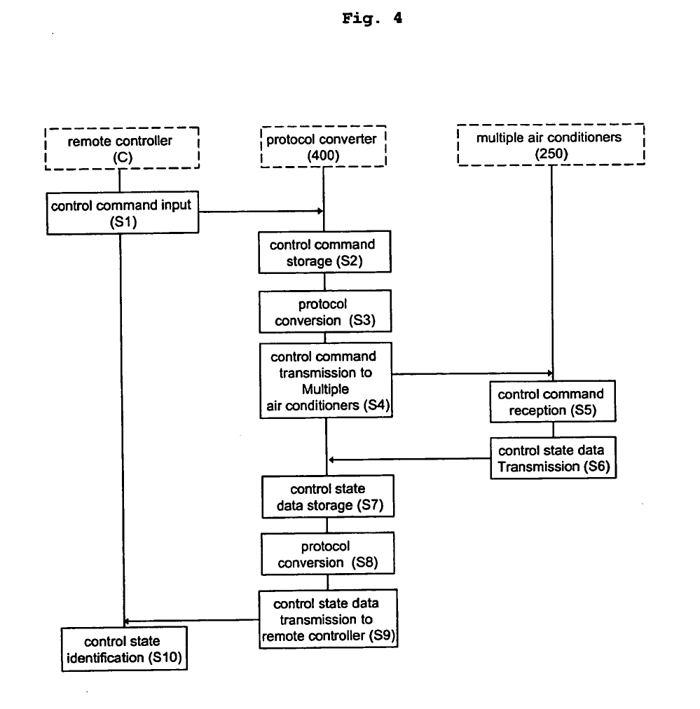

FIG. 4 shows a flowchart illustrating a method for operating the central control system for the multiple air conditioners in accordance with the present invention.

As shown in FIG. 4, a control command in the form of an Ethernet communication protocol signal for operating multiple air conditioners is input into remote controller C (S1). The control command as the Ethernet communication protocol signal is transmitted to the protocol converter 400 through the Internet network. The protocol converter 400 stores the control command in a buffer (S2), converts the control command based on the Ethernet communication protocol into a control command in the form of an air conditioner communication protocol signal (S3), and transmits the control command based on the air conditioner communication protocol to the multiple air conditioners 250 (S4).

After receiving the control command and performing control operations based thereon (S5), the multiple air conditioners 250 generate data representing control or operating conditions and transmit the control condition data to the protocol converter through the dedicated line (S6). The control condition data is in the form of a signal based on the air conditioner communication protocol.

The protocol converter 400 receives the control condition data, stores the control condition data in the buffer (S7), converts the control condition data based on the air conditioner communication protocol into control condition data based on the Ethernet communication protocol (S8), and transmits the control condition data to the remote controller C (S9).

The remote controller C receives the control condition data through the Internet network and outputs or displays a result of the control. The manager or operator, who input the control command at the remote location, can identify the result of the control operation associated with the multiple air conditioners (S10).

As is apparent from the above description, the present invention provides a central control system for controlling multiple air conditioners and a method for operating the same. The multiple air conditioners are connected through a dedicated line based on an air conditioner communication protocol, to a central controller. The manpower and time required for controlling and managing the multiple air conditioners can be reduced through the implementation of a remote control operation. The stability and reliability of an air conditioner control operation can be improved by converting a remote control command based on an Ethernet communication protocol, which is transmitted and received through an Internet network, into a control command based on an air conditioner communication protocol, such that the control command can be recognized by the multiple air conditioners. It should be noted that it is within the spirit and scope of the present invention to operate in any suitable wired or wireless network.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A central control system that controls multiple air conditioners including at least one outdoor device and a plurality of indoor devices, said central control system comprising:
a central controller connected to the multiple air conditioners through a dedicated line, for transmitting and receiving signals based on an air conditioner communication protocol, to control the multiple air conditioners, the central controller also connected to an external Internet network, for transmitting and receiving signals based on an Ethernet communication protocol, to receive a control command for the multiple air conditioners; and
a protocol converter that performs a communication protocol conversion of a signal, whereby the control command input at a remote location can be transmitted to the multiple air conditioners through the Internet network.

2. The central control system as set forth in claim 1, wherein the central controller comprises:
a key input device that receives the control command associated with the multiple air conditioners; and
an output device that outputs control conditions of the multiple air conditioners operated according to the control command.

3. The central control system as set forth in claim 1, wherein the central controller comprises:
a control program driver that drives a control program accessible by a GUI (Graphic User Interface) for controlling the multiple air conditioners.

4. The central control system as set forth in claim 3, wherein the central controller comprises:
a control program transmitter that transmits the control program by downloading through an Internet browser by a remote controller in response to a request from the remote controller received through the Internet network.

5. The central control system as set forth in claim 1, wherein the central controller comprises:
a signal storage device that stores the control command received through the Internet network;
an Internet data storage device that stores data for accessing the Internet network and IP address data; and
a controller that controls the flow of signals transmitted and received through the Internet network, and controls the protocol converter for performing a communication protocol conversion of a signal.

6. The central control system as set forth in claim 5, wherein the protocol converter is connected by a cable to the central controller through a serial port of the central controller.

7. A method of operating a central control system for multiple air conditioners, comprising:
receiving a control command for the multiple air conditioners that is transmitted from a remote controller over an Internet network;
converting the received control command into a control command based on an air conditioner communication protocol;
transmitting the control command based on the air conditioner communication protocol to the multiple air conditioners;
performing a control operation of the multiple air conditioners in response to the control command based on the air conditioner communication protocol; and
transmitting data representing control conditions of the multiple air conditioners to the remote controller over the Internet network.

8. The method as set forth in claim 7, further comprising:
converting the control condition data into control condition data based on an Ethernet communication protocol prior to transmission over the Internet network.
